(19) United States
(12) Patent Application Publication
(10) Pub. No.: US 2018/0028957 A1
(43) Pub. Date: Feb. 1, 2018

(54) Particle Filter for an Exhaust System as well as a Procedure for the Manufacture of a Particle Filter

(71) Applicant: AUDI AG, Ingolstadt (DE)

(72) Inventor: Felix KNACKSTEDT, Ingolstadt (DE)

(73) Assignee: AUDI AG, Ingolstadt (DE)

(21) Appl. No.: 15/661,044

(22) Filed: Jul. 27, 2017

(30) Foreign Application Priority Data
Jul. 27, 2016 (DE) 102016213769.7

(51) Int. Cl. B01D 46/24; F01N 13/00; G01M 15/10; F01N 3/021

(52) U.S. Cl. CPC B01D 46/2403; F01N 3/021; F01N 13/008; G01M 15/104; B01D 2273/18; B01D 2279/30; F01N 2560/025

(57) ABSTRACT

A particle filter for an exhaust system, in particular of a motor vehicle, provided with a housing having an exhaust gas inlet and an exhaust gas outlet and a porous filter body being disposed in the housing, the filter body is provided with a cover surface and has a large number of flow channels running parallel in the direction of flow. Accordingly, in the filter body, a sensor well is formed to accommodate a sensor element, where such sensor well penetrates at least one of the flow channels. The disclosure further also concerns a procedure for the manufacture of a particle filter.

### FIELD

The invention concerns a particle filter for an exhaust system, in particular of a motor vehicle, with a housing having an exhaust gas inlet and an exhaust gas outlet and a porous filter body being disposed in the housing, wherein the filter body is provided with a cover surface and has a large number of flow channels running parallel in the direction of flow. The invention furthermore concerns a procedure for the manufacture of a particle filter.

### BACKGROUND

The exhaust system may be associated with an exhaust-generating system, for example of an internal combustion engine or the like. The exhaust system serves to remove exhaust gas from the exhaust-generating system in the direction of or to an external environment, respectively. The exhaust system has at least one exhaust gas cleaning system, i.e. the particle filter. The same serves to remove particles, for example soot particles, from the exhaust gas flowing through the exhaust system. In addition to the particle filter, of course, at least another exhaust gas cleaning system, for example a catalytic converter and/or another particle filter, may be present in the exhaust system. The exhaust gas flowing through the exhaust system, in particular the entire exhaust gas, is supplied to the particle filter.

### SUMMARY

The purpose of the invention is to propose a particle filter for an exhaust system which is advantageous in comparison with known particle filters, in particular by improving the use of the installation space, while at the same time achieving a higher efficiency rate.

In the filter body, a sensor well is formed to accommodate a sensor element, where such sensor well penetrates at least one of the flow channels.

The particle filter has the housing as well as the filter body, which is disposed in the housing. The housing embraces the filter body, preferably completely, in particular in the circumferential direction in respect of the longitudinal center line of the filter body. The housing has the exhaust gas inlet as well as the exhaust gas outlet. The exhaust gas inlet is associated, for example, with an exhaust gas inlet connection, and the exhaust gas outlet is associated with an exhaust gas outlet connection, wherein, via the same, preferably, one exhaust gas line each is connected with the exhaust gas inlet and the exhaust gas outlet, respectively.

The filter body is preferably made from a porous material, for example a ceramic material. For example, silicon carbide (SiC), cordierite, or a similar material are used. The filter body is extruded from the material, for example. During extrusion, the flow channels running parallel in the direction of the flow can also be formed in the filter body. Via at least one part of the flow channels, flow is possible between the exhaust gas inlet and the exhaust gas outlet. In the filter body, a large number of such flow channels is formed.

Preferably, the exhaust gas is forced to flow from that channel of the flow channels through which it initially flows into, respectively, in the direction of another one of the flow channels, for example by closing at least one of the flow channels. Once the exhaust gas flows into the closed flow channel, it must flow over through the porous filter body into another one of the flow channels through which it can afterwards flow to the exhaust gas outlet.

The filter body has the cover surface which is at least largely closed, in particular continuously closed. The cover surface is impermeable to fluids, meaning that it does not permit the passage of exhaust gas. The cover surface may be applied, for example, during extrusion or via a processing step that is carried out after extrusion. For example, the cover surface is produced by coating the porous filter body. The sensor well may penetrate through the cover surface. In a particularly preferred manner, however, the sensor well is provided within the filter body, whereas the cover surface is closed at the same time. For example, for such purpose, only the connection lines of the sensor element penetrate the cover surface, which is otherwise continuously closed.

The sensor well formed in the filter body serves to accommodate the sensor element. The sensor element can be or is arranged in the sensor well. The sensor element is preferably provided as a sensor or has at least such a sensor. The sensor may be present in the form of a lambda sensor or the like. The sensor well is formed in the filter body in such a manner that the exhaust gas flowing through the particle filter flows to and/or over the sensor element. For such a purpose, the filter body penetrates at least one of the flow channels. Such an arrangement permits a particularly space-saving integration of the particle filter with the sensor element.

As a result of the arrangement of the sensor element in the filter body, in a particularly preferred manner, a sensor element located upstream from the particle filter and/or a sensor element located downstream from the particle filter is entirely unnecessary. In case the sensor element is provided as a lambda sensor or has such a sensor, the sensor can be operated in the manner of a pre-cat lambda sensor or as a post-cat lambda sensor. The lambda sensor can additionally either be provided as a binary lambda sensor or as a broadband lambda sensor.

According to one embodiment of the invention, on an inlet side of the filter body facing the exhaust gas inlet as well as on the outlet side facing the exhaust gas outlet, several of the flow channels may be closed at least partially by means of an inserted sealing plug. The sealing plug, or the sealing plugs, extend solely over a fraction of the filter body in the axial direction. For example, the sealing plug has an extension in the axial direction which is no more than 5%, no more than 2.5%, no more than 1%, no more than 0.5%, or no more than 0.1% of the longitudinal extension of the filter body in the axial direction.

The sealing plug is provided in such a manner that it completely closes off the flow of the flow channels in which it is disposed. The sealing plug can either be disposed in the flow channel on the inlet side or on the outlet side of the filter body. Accordingly, either the flow of the exhaust gas supplied via the exhaust gas inlet into the respective flow channel or the flow from the flow channel in the direction of the exhaust gas outlet is closed off. Accordingly, the exhaust gas present in the flow channel must in turn flow through the porous filter body in the direction of another flow channel, in particular in the direction of a flow channel which extends to the outlet side and which is not closed on such end.

Preferably, both on of the inlet side as well as on the outlet side, several flow channels are closed by means of such a sealing plug.

Within the scope of another embodiment of the invention, on the inlet side, those flow channels are closed which are not closed on the outlet side, and/or on the outlet side, those flow channels are closed which are not closed on the inlet side. Preferably, on the outlet side, flow channels are closed which pass through the filter body in the axial direction, i.e. which extend from the inlet side to the outlet side. Then, at least one part of the flow channels is closed on the inlet side which exit on the outlet side, i.e. which extend in the axial direction through the entire filter body and which, additionally, are not closed on the outlet side, meaning that they are not provided with a sealing plug on the outlet side.

Formulated the other way around, on the outlet side, those flow channels are closed which are not closed on the inlet side. In other words, each and every one of the flow channels is either closed on the inlet side or on the outlet side, i.e. by means of a sealing plug, whereas it is not closed on the respective other side, i.e. on the outlet side or on the inlet side. Preferably, one part of the flow channels is closed on the inlet side and not closed on the outlet side, whereas another part of the flow channels is closed on the outlet side and not closed on the inlet side.

Within the scope of another embodiment of the invention, it is possible that the flow channels are closed on the inlet side by means of a first subset of the sealing plugs and the flow channels are closed on the outlet side by means of a second subset of the sealing plugs, wherein the first subset contains a first number of the sealing plugs and the second subset contains a second number of the sealing plugs, wherein the first number and the second number are the same or do not differ by more than 1%, more than 2.5%, more than 5%, more than 7.5%, or by more than 10%.

The aforementioned sealing plugs can therefore be divided into the first subset and the second subset, wherein the first subset serves to close off flow channels on their inlet side and the second subset serves to close off flow channels on their outlet side. Each subset contains a certain number of sealing plugs, i.e. the first number is contained in the first subset and the second number is contained in the second subset.

Preferably, on its inlet side, the filter body has the same cross-section as on its outlet side. Preferably, in this case, on the inlet side of the flow channels, the same number of sealing plugs is provided as on the outlet side of the flow channels so that the first number matches the second number or is at least similar. Based on different cross-sections or based on the penetration of the sensor well into at least one of the flow channels, however, the first number may be different from the second number or vice versa. In this respect, however, the difference is preferably limited to the specified values.

Each flow channel has a wall surface which limits the same. This wall surface can be provided with a catalytic coating, which can also be referred to as a three-way coating.

The catalytic coating serves for catalytic reduction of contaminants contained in the exhaust gas. In this respect, the particle filter not only serves to remove particles from the exhaust gas, but is also serves to convert the contaminants into less harmful products. It is particularly preferred when the coating is also provided on at least one part of the sealing plugs by means of which the flow channels are closed on their inlet side or on their outlet side.

In another particularly preferred embodiment of the invention, at least one of the flow channels penetrated by the sensor well is closed, on the outlet side, by means of another sealing plug. This is in particular the case where several flow channels terminate in the sensor well or where the sensor well penetrates several flow channels, respectively. In this case, it is possible that, via the sensor well, flow is permitted between one of the flow channels which is not closed on its inlet side and another one of the flow channels which is not closed on its outlet side, as a result of which exhaust gas can flow, without passing the filter body, from the first-mentioned flow channel into the last-mentioned flow channel.

In this case, unfiltered or at least almost unfiltered exhaust gas can pass through the particle filter. To prevent this, the flow channel penetrated by the sensor well should be closed on the outlet side by means of another sealing plug, at least as long as no outlet-side sealing plug has already been disposed in such a flow channel. Similarly to the above indications, the other sealing plug can also be provided with the catalytic coating or—alternatively—it may be without such a coating and it may have no coating whatsoever in this regard.

According to another preferred embodiment of the invention, the sensor well penetrates through the cover surface of the filter body. In this respect, the sensor well projects through the cover surface of the filter body and into the same, where it penetrates at least one of the flow channels, although preferably several of the flow channels. The sensor well, with its sides open, is therefore present in the filter body. Alternatively, of course, the sensor well can be formed in the filter body, whereas the cover surface encompasses the sensor well or at least a terminal opening of the sensor well at least partially, and it is particularly preferred that it completely closes off the same. In this case—as was already explained above—it is possible that only at least one connection line of the sensor element is conducted towards the outside from the sensor well through the cover surface.

In another embodiment of the invention, the sensor well passes through the filter body in the radial direction with respect to a longitudinal center line of the filter body by at least 10%, at least 20%, at least 25%, at least 30%, at least 40%, or at least 50%. The sensor well must at least have certain dimensions to permit disposing the sensor element in the sensor well. Preferably, the sensor well additionally has, in the radial direction and/or the axial direction and/or in the tangential direction, larger dimensions than the sensor element that is disposed therein in order to allow exhaust gas to flow to and/or over the same without any problem. Based on the dimensions of the filter body, this means that the sensor well has at least one of the aforementioned values in terms of size. In a particularly preferred manner, the sensor well is larger in the radial direction than the sensor element, or at least the part of the sensor element disposed in the sensor well.

In addition or alternatively, within the scope of a preferred embodiment of the invention, the sensor well may, in the axial direction and/or the in tangential direction with respect to the longitudinal center line, pass through the filter body by at least 5%, at least 10%, at least 15%, at least 20%, or at least 25%. Basically, for such a purpose, reference is herewith made to the above explanations.

The invention further concerns also a procedure for the manufacture of a particle filter for an exhaust system, in particular a particle filter as specified above, wherein the particle filter has a housing having an exhaust gas inlet and an exhaust gas outlet and a porous filter body being disposed in the housing, wherein the filter body is provided with a cover surface and has a large number of flow channels running parallel in the direction of flow. Accordingly, in the filter body, a sensor well penetrating at least one of the flow channels is formed to accommodate a sensor element.

The advantages of such an embodiment of the particle filter and such a procedure for its manufacture, respectively, have been already been pointed out. Both the procedure as well as the particle filter can be refined pursuant to the above embodiments, to which reference is herewith made.

Within the scope of a preferred embodiment, on the inlet side of the filter body facing the exhaust gas inlet as well as on the outlet side facing the exhaust gas outlet, several of the flow channels may at least partially be closed by means of an inserted sealing plug, and at least one of the flow channels penetrated by the sensor well can be closed on the outlet side by means of another sealing plug as long as the flow channel has not been closed by means of a sealing plug on the outlet side.

Such a procedure has also already been indicated above.

### BRIEF DESCRIPTION OF THE DRAWINGS

The invention will next be explained below in more detail with reference to the sample embodiments shown in the drawing, although without restricting the invention in any manner.

FIG. 1 is a schematic representation of a longitudinal section through a particle filter for an exhaust system, and

FIG. 2 is a schematic representation of a cross-section through the particle filter.

### DETAILED DESCRIPTION OF THE DRAWINGS

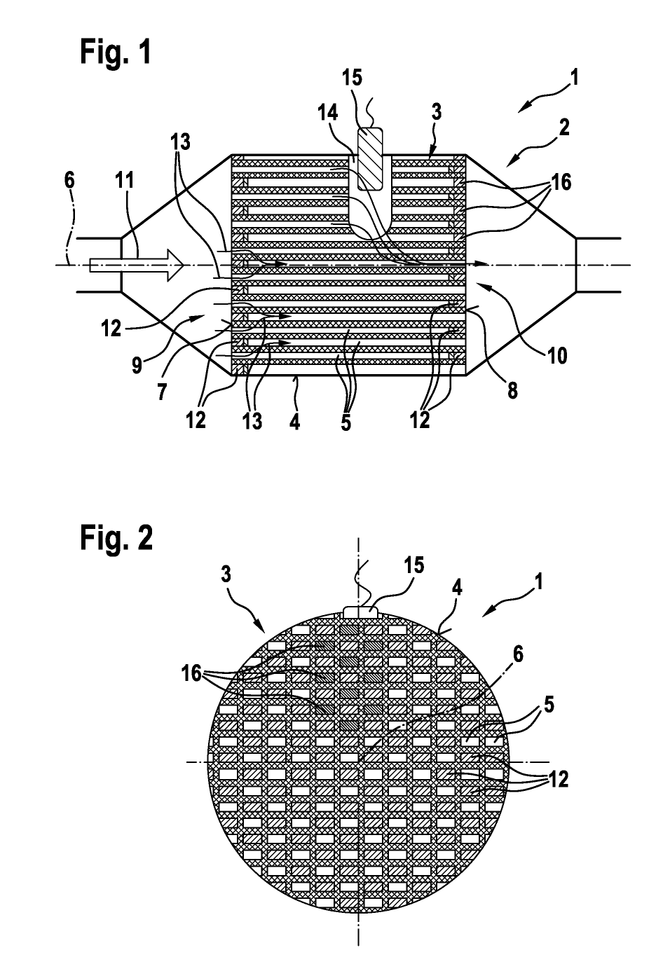

FIG. 1 shows a longitudinal section through a particle filter 1 for an exhaust system. The particle filter 1 has a housing 2, which is merely indicated in the drawing. In the housing 2, a filter body 3 is disposed, which is made from a porous material and which is preferably provided with a catalytic coating. The filter body 3 has a cover surface 4, which is for example provided in the form of a coating and/or by means of a respective treatment of the filter body 3. The filter body 3 is preferably disposed in the housing 2 in such a manner that its cover surface 4 is arranged at a distance from the housing 2. Alternatively, however, an embodiment of the particle filter 1 can also be carried out wherein the cover surface 4 of the particle filter 3 lies against an internal circumferential surface of the housing 2, in particular in a continuous manner in the circumferential direction.

In the filter body 3, a large number of flow channels 5 running parallel in the direction of flow is provided, only some of which are identified in this drawing by way of an example. It can be seen that the filter body 3, with respect to its longitudinal center line 6, has a cylindrical shape, in particular a circular cylindrical shape. However, other shapes of the filter body 3, for example a conical shape, can also be realized. On its front side, the filter body 3 has two areas 7 and 8 which are connected with each other via the cover surface 4. In the case of the cylindrical respectively circular cylindrical shape of the filter body 3, the areas 7 and 8 have the same surface area, or at least a similar surface area. The area 7 is located on an inlet side 9, whereas the area 8 is located on an outlet side 10 of the filter body 3.

Exhaust gas flows over the particle filter 1, respectively over the filter body 3, in the direction of the arrow 11. Both on the inlet side 9 as well as on the outlet side 10, several flow channels 5 are hermetically closed by means of an inserted sealing plug 12. For the inlet side 9, this means that the exhaust gas can not flow into the respective flow channel 5. However, in case the flow channel 5 is closed off on the outlet side 10, the exhaust gas then can not flow through it out of the filter body 3. Preferably, each and every one of the flow channels 5, in particular each and every one of the flow channels 5 passing completely through the filter body 3 in the axial direction, is closed either on its inlet side 9 or on the outlet side 10 by means of such a sealing plug 12.

Accordingly, for example, the flow through the filter body 3 occurs as shown by the arrows 13. Arrows 13 show, by way of example, that whereas the exhaust gas flows into one of the non-closed flow channels 5 on the inlet side 9, it can no longer flow out of the same because such a channel is closed on the outlet side 10. Therefore, the exhaust gas must pass through the porous filter 3 to a flow channel 5 which is open on the outlet side 10. This passage or the transfer through the filter body 3 cleans the exhaust gas, in particular by at least partially removing particles from it.

In the filter body 3, a sensor well 14 is formed, which serves to accommodate a sensor element 15, for example in the form of a lambda sensor. For example, the sensor well 14 is provided in the form of a bore, therefore having a circular cylindrical area, which on its end is terminated by a dome-shaped area, in particular an area in the shape of a partial sphere. The sensor well 14 preferably passes through the cover surface 4 of the filter body 3. Furthermore, the sensor well 14 at least partially penetrates at least one of the flow channels 5.

This means that, initially, despite the sealing plugs 12, flow is possible between the flow channels 5 which are not closed on the inlet side 9 via the sensor well 14 and the flow channels 5 which are not closed on the outlet side 10. Accordingly, it is possible that exhaust gas, without prior passage through the filter body 3, can flow through the filter body 3 in the longitudinal direction. To prevent this, in addition to the sealing plugs 12, additional sealing plugs 16 are provided. They are preferably disposed on the outlet side of those flow channels 5 penetrated by the sensor well 14 and which would otherwise not be closed on the outlet side, meaning that they would not have any sealing plug 12.

FIG. 2 shows a schematic representation of the cross-section of the particle filter 1 on the outlet side 10. Here, the outlines of the sensor well 14 are indicated. Once again, it is shown that on the outlet side 10, those flow channels 5 which are at least partially penetrated by the sensor well 14 are closed by means of the additional sealing plugs 16.

The described embodiment of the particle filter 1 makes it possible to achieve very low emission threshold values, and at the same time to comply with diagnostic requirements, since unfiltered passage of the exhaust gas through the particle filter 1 is prevented by the additional sealing plugs 16. The filter body 3, respectively the flow channels 5, can additionally be provided with a catalytic coating, as a result of which a catalytic converter is integrated in the particle filter 1. This leads to a significant cost reduction.

1. A particle filter for an exhaust system, in particular of a motor vehicle comprising: provided with a housing having an exhaust gas inlet and an exhaust gas outlet and a porous filter body being disposed in the housing, wherein the filter body is provided with a cover surface and has a large number of flow channels running parallel in the direction of flow, wherein on the inlet side of the filter body facing the exhaust gas inlet as well as on the outlet side facing the exhaust gas outlet, wherein several of the flow channels are closed by an inserted sealing plug, wherein on the inlet side, those of the flow channels are closed which are not closed on the outlet side and, on of the outlet side, those of the flow channels are closed which are not closed on the inlet side, and wherein, in the filter body, a sensor well passing through the cover surface which penetrates several of the flow channels is formed to accommodate a sensor element, wherein the flow channels penetrated by the sensor well are closed on the outlet side by additional sealing plugs.

2. The particle filter according to claim 1, wherein the flow channels on the inlet side, are closed by a first subset of the sealing plugs, and the flow channels on the outlet side, are closed by means of a second subset of the sealing plugs, wherein the first subset contains a first number of the sealing plugs and the second subset contains a second number of the sealing plugs, wherein the first number and the second number are the same or do not differ by more than 1%, more than 2.5%, more than 5%, more than 7.5%, or more than 10%.

3. The particle filter according to claim 1, wherein the sensor well, in the radial direction with respect to a longitudinal center line of the filter body, penetrates the filter body by at least 10%, at least 20%, at least 25%, at least 30%, at least 40%, or at least 50%.

4. The particle filter according to claim 1, wherein the sensor well, in the axial direction and in the tangential direction with respect to the longitudinal center line, penetrates the filter body by at least 5%, at least 10%, at least 15%, at least 20%, or at least 25%.

5. A procedure for the manufacture of a particle filter for an exhaust system wherein the particle filter has a housing having an exhaust gas inlet and an exhaust gas outlet and a porous filter body being disposed in the housing, wherein the filter body is provided with a cover surface and has a large number of flow channels running parallel in the direction of the flow, wherein on the inlet side of the filter body facing the exhaust gas inlet as well as on the outlet side facing the exhaust gas outlet, several flow channels are closed by an inserted sealing plug, wherein, on the inlet side, those of the flow channels are closed which are not closed on the outlet side and, on the outlet side, those of the flow channels are closed which are not closed on the inlet side and wherein, wherein in the filter body, a sensor well passing through the cover surface is formed to accommodate a sensor element, where such sensor well penetrates several of the flow channels, wherein the flow channels penetrated by the sensor well are closed on the outlet side by additional sealing plugs.
